(19) United States
(12) Patent Application Publication
(10) Pub. No.: US 2008/0017559 A1
(43) Pub. Date: Jan. 24, 2008

(54) Automated Filtration Method and Filtering System for Practicing the Method

(76) Inventors: Michiel Rutgers van der Loeff, Bremerhaven (DE); Ingrid Voege, Windhoevenweg (DE); Heiko Lilienthal, Walter-Delius-Strasse (DE)

Correspondence Address: LAW OFFICES OF KARL HORMANN, 86 SPARKS STREET, CAMBRIDGE, MA, 02138, US

(21) Appl. No.: 11/659,657

(22) PCT Filed: May 23, 2005
(86) PCT No.: PCT/DE05/00955

§ 371 Date: Feb. 5, 2007

(30) Foreign Application Priority Data
Aug. 13, 2004 (DE) 10 2004 040 248.5

(51) Int. Cl. G01N 1/00; G01N 1/28

(52) U.S. Cl. 210/142; 210/710

(57) ABSTRACT

A filtration method is fully automated in all method steps (filling, filtering, rinsing) and works in a closed method cycle with two simple filtrations (A, B) In filtration A, a water sample (WP) obtained, for example, directly from the sea, is filtered to filter off substance particles and temporarily stored (AB). The filtrate is then mixed with precipitate-forming chemicals (CB) and introduced to filtration B, in which the dissolved substance components are filtered off by absorption on the precipitate.

### BACKGROUND OF THE INVENTION

1. Field of the Invention

The present invention relates to an automated filtration method for the continuous filtering of water samples for the analysis of substances contained therein and to an automated filtration system for practicing the method.

Automated continuous filtering of water samples is necessary in many fields of application for analyzing and monitoring the water condition and the water composition. By automating it, service personnel, in particular, can be reduced and high continuity of sample testing can be ensured overnight even. Fields of application for environmental protection are, for instance, water tests in water and sewage treatment plants, testing of waste water in chemical production facilities and places of feeding into public water and environmental research tests of sea water extending over long periods in the realm of ocean biology, for instance for observing the export of particles from surface regions of the sea to lower layers of the sea. For instance, the isotope thorium 234 (²³⁴Th) is produced in sea water as a result of the decaying uranium isotope 238 (²³⁸U). Where no particles are present ²³⁴Th will be present in dissolved form in isotopic equilibrium with ²³⁸U. However, ²³⁴Th quickly bonds to particles, and if particles precipitate from the cover layer of the ocean they take ²³⁴Th along and thus generate a deficit of ²³⁴Th in the cover layer. Therefore, measuring particulate and dissolved ²³⁴Th in the cover layer makes it possible to calculate the export of particles into the depth.

2. The Prior Art

From DE 198 36 292 A1 there is known a filtration method for taking samples or particles, especially in sea water and fresh water, from which the instant invention is proceeding as the closest state of the art. In this arrangement, the filtration system includes a motor-driven sample changer having mounted thereon sample receiving devices structured as filters. The sample changer is moveable such that the filters may be successively moved into a rinsing position, a sample-taking position and/or a contamination position for preserving the taken sample. In one disclosed embodiment, the sample changer is of a wheel-like structure and is provided with twenty-one filters. By rotating the sample changer, the filters are moved into their active position for executing the process steps. Moreover, the filtration system is provided with at least one pump which is connected to the filtration system by way of appropriate power units such that the pump selectively feeds fluid surrounding the filtration system through or to a filter disposed in the rinsing position of the sample-taking position. The quantity of fluid fed by the pump is determined by a flow meter. The motor and the pump are automatically activated at predetermined times such that at a predetermined time at least one filter is rinsed and at least one sample is taken by the corresponding filter and/or at least one contamination of the filter takes place, under the control of an electronic circuit which can be programmed by way of a communications interface with predetermined times and predetermined operational sequences. The components of the filtration system are powered from a power storage. Thus, the filtration process includes a rinsing step, a rotation step for moving the filters, a sample-taking step, a further rotation step, a contamination step for preserving the taken sample and a further rotation step for moving a further filter into its rinsing position.

The known filtration system is used in deep-sea anchorings, for instance from research ships, where it detects, completely independently, the particles contained in sea water at a predetermined depth. Its automation serves to improve the reliability of the measuring results and to simplify the execution of the process in terms of handling and expense.

In the known filtration process it is, however, disadvantageous that each filter only provides for one filtration with untreated sea water so that only those particles can by detected which can be filtered directly from the water sample. Yet specific substances in the water, for instance ²³⁴Th occur in the sea water in a particulate as well as in a dissolved state. These substances cannot be completely detected by the known filtration process. Further, the diameter of the wheel-like sample-changer of the known filtration system is determined by the number of filters to be used since all filters are mounted in the filter wheel at the same time. However, since the diameter of the wheel-like sample-changer is significantly limited in the anchoring, it is not possible simultaneously to apply a very large number of filters which, in turn, limits the time for which the filtration system can be used during frequent filter changes or the interval of filter changes. Lastly, the used filters are preserved by contamination. But since they remain within the water the release of bonded particles cannot be avoided which may lead to distorted measuring results.

A fully automatic filtration of water samples for the complete and highly precise detection of predetermined components directly from the sea is now made possible by the filtration process in accordance with the invention. Following a first filtration of an untreated water sample which may be gathered, for instance, by a direct feed duct to the filtration system which may be installed, for instance, on a research vessel at sea, chemical additives are added to the filtered water sample followed by an induced precipitation in the filtered water of dissolved substances adsorbed by the chemical additives. The precipitated substances are then filtered out by further filtration with a further filter. Both loaded filters may then, without further chemical or mechanical pre-treatment, be measured by a beta or gamma counter (counter for radioactive decay). The specific application of the filtration process in accordance with the invention to ²³⁴Th the activity of which in the sea is at present the subject of intensive research makes possible direct filtration of sea water samples in regions near the surface for initially filtering out particulate ²³⁴Th. By adding chemicals to the pre-filtered sea water sample MnO₂ precipitation may be carried out which quantitatively adsorbs ²³⁴Th dissolved in sea water and precipitates with it. A subsequent filtration of the produced MnO₂ then leads to the detection of the preciously dissolved ²³⁴Th the beta activity of which may be counted directly. Together, both filtrations guarantee the complete detection of particulate and dissolved ²³⁴Th in the water sample.

DE 198 42 667 B4 discloses a method of capturing acidic and basic substances contained in a gas, such as, for instance, the atmosphere, by producing a sample for analyzing in which the sample is subjected to two filtration steps in a capturing apparatus provided with two separate capturing elements, only one of which, however, is structured as a porous filter for detecting the basic component of the substance to be tested as particles and vapor. The second capturing element, however, operates as an adsorptive liquid; it is not the filtered substance which is fed to it but rather the component portion filtered out by the first filtration. Therefore, the known method operates in accordance with a chemistry (salt formation, adsorption) totally different from the invention, sequentially rather than parallel. It serves mainly for detecting onerously smelling substances (basic compounds such as ammonia and amine after their reaction with acidic substances) in the air.

Furthermore, the July 1990 Report No. 12 of the JGOFS-Program (Joint Global Flux Study), “Isotropic Tracers in U.S. JGOFS” containing a pre-publication by W. S. Moore “Sampling and Analytical Requirements for a Global Study” (Contribution 11.14, pp. 106-110) refers to a metal concept for an automatic detection of ²³⁴Th. It does, however, apply to an adsorption rather than filtration. It call for guiding a water jet from a hose through different Mn fiber packages arranged simultaneously on an elongated base plate. Thereafter, the charged Mn fiber packages are counted by a beta counter. Accordingly, it pursues an approach wholly different from that of the invention and in which the degree of automation is a function of the number of the parallel Mn fiber packages.

Furthermore, fully automatic aerosol sample taking devices for use on research ships are known (see pamphlet sheet “Vollautomatisches High-Volume-Aerosol-Probenahme-Gerät ISAP® 3000”) available in the Internet under http://www.isap.com.probe/aerosol-probenahme-geraet-isap-3000.html, state 29 Jun. 2004, in which an event-oriented change of filters (see pamphlet “Filterwechsel”, available in the Internet under http://www.derenda.de/produkte_filterwechler_peltier.html. state 29 Jun. 2004) takes place from a filter magazine with thirty-one filters, each filter being useable several times to take advantage of its capacity. However, the underlying filtration process again uses a totally different chemistry from the filtration process in accordance with the invention. From the pamphlet “Digitel Aerosol Sammler DHA-80”, available in the Internet at http://digitel-ag.ch/dha80beschr.htm, state 29 Jun. 2004, a similar apparatus is known which is provided with a filter magazine of fifteen filters mounted in a filter brackets. They are automatically changed into the flow direction by means of an automatic changer, at a predetermined time. However, no statements are made in any of the mentioned pamphlets about the manner in which the change of filters is functioning. Automatic filter changing is also known, for instance, from the abstract of JP 2001 082407 A; however, in this case a manipulator arm is employed for changing the filters.

### OBJECT OF THE INVENTION

It is, therefore, an object of the invention to make possible filtration of substances of various phenotypes within a water sample whereby the different phenotypes are to be detected in different filtering operations. It is to achieve a high degree of automation while at the same time ensuring reliable measuring results without the filtration method or filtration system becoming very complex, difficult to handle and expensive. Furthermore, independent operation is to be possible over extended periods at a relatively frequent continuous taking of samples. The manner in which an automatic filtration method for continuously filtering water samples for analyzing components and an automated filtration system of the kind described supra are accomplished by the inventive object can be gleaned from the product claim. Advantageous improvements to be described in greater detail hereinafter, are defined in corresponding sub-claims.

### SUMMARY OF THE INVENTION

Hitherto, the detection of thorium was done entirely manually and without automatic intermediate steps. The taking of samples, the treatment of the samples, intermediate cleaning were performed manually. The samples filtered in a first step of filtration were filled into canisters, and chemicals were added into these canisters by pipettes and the MnO₂ precipitation was produced by sufficient shaking. Thereafter, the canister were connected to filter units, and their contents were filtered. Thereafter, the filters were removed individually, dried, mounted and inserted into beta counters. The canisters and filtering units were finally rinsed manually with an acid and distilled water. In contrast, in the automatic filtration process all steps up to the production of the countable filters are completely automated. It provides for significant savings of time. During an expedition an almost continuous taking of samples of surface water has now become possible without several technicians operating in shifts. A single person may attend to the unit as an auxiliary activity. Taking samples on board “ships of opportunity” has thus become possible. Furthermore, compared to the manual process the measuring results have become highly reproducible. Automation results in a precise definition and execution of all of the individual steps of the process. The hitherto particularly critical rinsing operation may be set such that no cleaning agents are carried over to a subsequent sample. In addition, the linking of filtration and beta measuring in one filer bracket is contributing significantly to the advantages of the automatic filtration process. The filters are placed into a holder in which they remain during filtration as well as while the beta activity is defined.

By applying the automated filtration process for a semi-continuous definition of the particulate and dissolved ²³⁴Th in the surface water of oceanographic sections, it is possible to define the geographic distribution of the export production, i.e. the export of particles from th euphotic zone into the depth. This constitutes an important parameter in detecting the carbon metabolism. Furthermore, semi-continuous filtration of sea water may be applied for defining chlorophyll a as a necessary calibration for the continuous definition of the fluorescence which by quenching displays a dependency of light. Finally, it is also possible, for instance, to precipitate and detect radio nuclides in waste water.

### DESCRIPTION OF THE SEVERAL DRAWINGS

The novel features which are considered to be characteristic of the invention are set forth with particularity in the appended claims. The invention itself, however, in respect of its structure, construction and lay-out, as well as manufacturing techniques, together with other objects and advantages thereof, will be best understood from the following description when read with reference to the drawings, in which:

FIG. 1 is a view of the automated filtration system; and

FIG. 2 is a block diagram of the automated filtration process.

### DETAILED DESCRIPTION OF THE PREFERRED EMBODIMENT

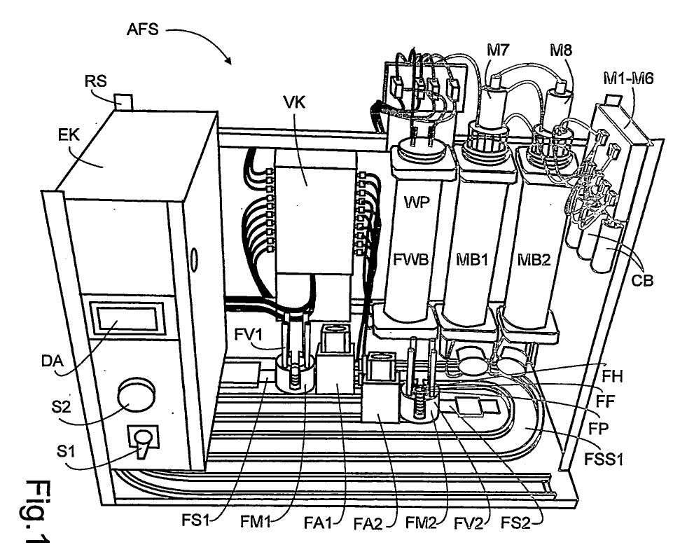

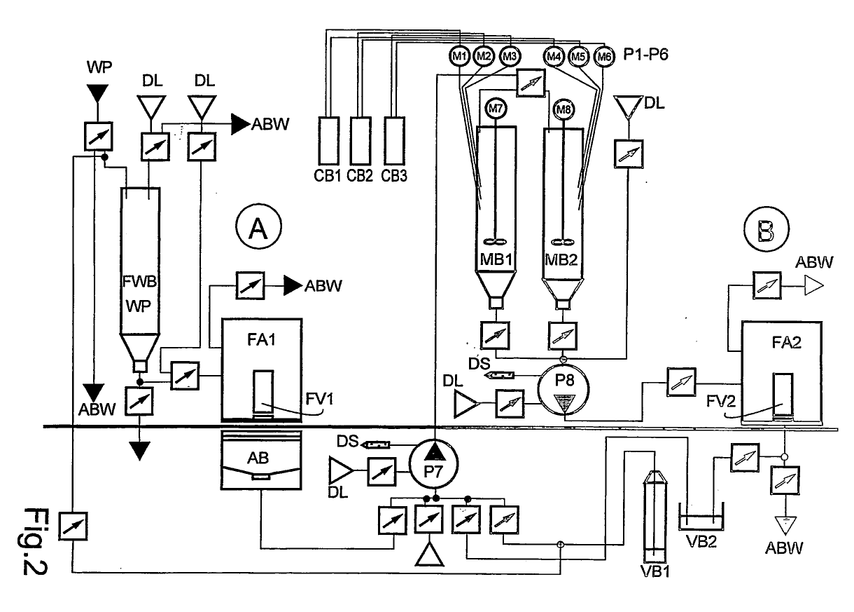

FIG. 1 depicts an automated filtration system AFS for practicing an automated filtration process for the continuous filtration of water samples WP for analyzing substances contained therein, with a frame structure RS within which the various components are arranged. In the right section of the frame structure RS there is provided a fresh water pressure container FWB which may be directly connected to the water to be tested (see FIG. 2). The freshly gathered water sample WP is collected in the fresh water pressure container FWB from where it is fed to a first filtration container FA1 (filtration A). The container FA1 is provided with an external filtering device FV1 consisting of a magazine FM1 for stacking filters and a filter shifter FS1. The filter FF (consisting of a filter frame FH and filter paper FP) which is the lowest at any given time is shifted by the filter shifter FS1 into the filtration container FA1. Following filtration A and before the next filtration B is commenced, the filter FF which is now lowest in the stack is moved into the filtration container FA by the filter shifter FS1 which leads to the previously charged filter FF to be shifted into a first guide rail FSS1 for storage and subsequent removal.

The water sample WP filtered in the first filtration container FA1 is temporarily stored in a catch container AB. Two alternatingly operable mixing containers MB1, MB2 are arranged adjacent to the fresh water pressure container FWB. While a water sample WP pre-filtered during filtration A is being blended with chemical in one of the mixing containers MB1, a pre-filtered and completely treated water sample WP in the other mixing container MB2 may be fed to a second filtration container FA2 or vice versa. The second filtration container FA2 is also provided with an external filtration device FV2 with a filter magazine FM2 for stacking filters and a filter shifter FS2 by means of which the lowest filter FF in the stack is moved into the filtration container FB2 and, following filtration, into a second guide rail FSS2. The function of the second filtration B corresponds to that of the first filtration A.

A precipitation-forming chemical is fed by motor-driven chemical pumps M1-M6 from storage containers CB into the mixing container not currently in use and is mixed therein by means of a motor M7, M8. Prior to renewed use, the mixing containers MB1, MB2 are rinsed and cleansed with a mixture of hydrochloric acid HCl and hydrogen peroxide H₂O₂ from a storage container VB2 and with distilled water from a storage container VB1 as well as with pressurized air. Furthermore, there are provided in the automated filtration system AFS a switch box VK for the corresponding terminal switches and valves (see FIG. 2) and a central processor EK with a display DA, main switch S1 and a emergency shut-down switch S2 for the automatic control of the filtration process.

The operation of the automated filtration system AFS of FIG. 1 and the automated filtration process carried out by it can be described with reference to the block diagram of FIG. 2.

The filtrations A and B, filter changes and rinsing operations are automated. All circuits, valves (indicated in FIG. 2 by oblique arrows), pump feeding and further manipulations are pneumatically driven by pressurized air DL. Filter frames with inserted filters are manually placed and replenished in two filter magazines FM1, FM2. Upon start-up of the system the filter frames are automatically fed from the filter magazines into the filtrations A and B. Thereafter, the process sequence runs fully automatically:
The fresh water pressure container FWB is filled with a water sample WP, e.g. sea water, and filtered by pressurized air (0.05 MPa) in filtration A.
The filtrate (=pre-filtered water sample WP) is stored in a catch container AB.
Following the predetermined filtration time a possible residual quantity of fluid in filtration container FA1 is disposed into a waste water area ABW, the filter FF is dried with pressurized air and the filter frame FH is ejected from the filtration A and collected in a guide rail SS1.
The fresh water pressure container FWB is now automatically cleansed with distilled water and after a predetermined time it is filled with a new water sample WP.
The filtrate is fed by a pneumatic pump P7 from the catch container AB into the mixing container MB1 or MB2. A rotor with a motor M7 starts and chemicals are added by peristaltic or hose pumps P1-P6 with adjustable pumping times. Upon the detection of ²³⁴Th solutions of NH₃, KMnO₄ and MnCl₂ are added consecutively.
Following the mixing operation the rotor stops. After an adjustable dwell time filtration B is commences by switching on the pneumatic pump P8.
The filtration B is discontinued when the filtration time (calculated on the basis of the sample interval and the time required for all further steps) has ended. The filtered volume is determined by a pressure sensor DS.
A possible residual volume is disposed into the waste water area ABW, the filter FF is dried with pressurized air, and the filter frame FH is removed from the filtration B and collected in a guide rail SS2.
The mixing container MB1 or MB2 and the filtration container FA2 are now rinsed with 1M HCl (with 10 ml/L H₂O₂) thereafter, three times, with distilled water and with pressurized air, from storage containers VB1, VB2.
A new filter frame FH is pushed into the filtration B, and the automated filtration can commence anew.
The filters FF stored and appropriately marked (filtration A or B, dates of sample taking) in the guide rails SS1, SS2 are manually placed into a corresponding beta or gamma counter for detecting the complete (particulate or dissolved) share of the radioactive thorium contents in the actual water sample WP.

What is claimed is:

1. A method of automated filtration for the continuous filtering of water samples for analyzing components comprising the processor-assisted cyclically repeatable method steps of:
filling a fresh water pressure container (FWB) with a water sample (WP);
inserting a filter (FF, Filtration A) into a first filtration container (FA1);
pumping the water sample (WP) through the filter (FF) in filtration A;
catching the water sample (WP) in a catch container (AB);
drying, removing and storing the filter (FF);
continuing pumping the pre-filtered water sample (WP) into a mixing container (MB1, MB2);
mixing the water sample (WP) with precipitation-forming chemicals (CB);
inserting a filter (FF, filtration B) into a second filtration container (FA2);
pumping the mixed water sample (WP) through the filter (FF) in filtration B;
disposal of the water sample (WP) in a waste water area (ABW);
drying, removing and storing the filter (FF) from the filtration B;
emptying into a waste water area (ABW) and rinsing of the fresh water pressure container (FWB) and of the mixing container (MB1, MB2).

2. The method of automated filtration of claim 1 including direct gathering of a water sample (WP) of sea water from near the surface.

3. The method of automated filtration of claim 2 including pumping two pre-filtered water samples (WP) into two different mixing containers (MB1, MB2) with the precipitation-forming chemicals (CD) acting upon the water sample (WP) in one of the mixing containers (MB1) alternating with pumping of the mixed water sample (WP) from the other mixing container (MB2) into filtration B.

4. The method of automated filtration of claim 3 including a pneumatic energy supply (DL0 of the pumps (p) and of all further driven elements (L, M).

5. The method of automated filtration of claim 4 including a time-controlled execution of the individual method steps.

6. The method of automated filtration of claim 5 including determination of the filtered volume of the water sample (WP) by a pressure sensor (DS).

7. An automated filtration system (AFS) for executing an automated filtration method for the continuous filtration of water samples (WP) for analyzing the components thereof, in particular in accordance with one of claims 1 to 6, comprising a fresh water pressure container (FWB) which is directly connected to the water to be tested and to a catch container (AB) by way of a first filtration container (FA1) provided with an external filtering device (FV1) for automatically changing filters (FF) from a filter magazine (FM), two mixing containers (MB1, MB2) connected by a first pump (P7) with the catch container (AB) and with a storage container (VB1, VB2) each for a least a cleaning fluid, by a second pump (P8) to a second filtration container (FA2) provided with an external filter device (FV2) for automatically changing filters (FF) from a further filter magazine (FM2) and by one further pump (P1-P6) to at least one storage container (CB) for a precipitation-forming chemical, the fresh water pressure container (FWB) and the mixing containers (MB1, MB2) being connected to a waste water disposal (ABW) and the energy being supplied by a pressurized air station (DL) and the energization of the pumps (P) and the connections by way of valves taking place by way of a central processor.

8. The automated filtration system (AFS) of claim 7 comprising a filtering device (FV) consisting of a vertical filter magazine (FM) of individual filters (FF) made of filter paper (FP) and a filter frame (FH) and a filter shifter (FS) for moving the lowest filter (FF) into the filtration container (FA) and for ejecting the charged filter (FF) from the filtration container (FA) into a guide rail (FSS) behind the filtration container (FA).

9. The automated filtration system (AFS) of claim 8 comprising filter magazines (FM) for stacking filters.

10. The automated filtration system (AFS) of claim 9 comprising a thorium-containing water sample (WP) from the open sea, NH₃, KMnO₄ and MnCl₂ as precipitation-forming chemicals and a solution of hydrochloric acid and hydrogen peroxide as well as distilled water for rinsing the fresh water pressure container (FWB) and of the mixing containers (MB1, MB2).
